(19) United States
(12) Patent Application Publication
(10) Pub. No.: US 2016/0241026 A1
(43) Pub. Date: Aug. 18, 2016

(54) RECONFIGURABLE POWER SUPPLY CELL FOR EFFICIENT BOOST AND BUCK-BOOST APPLICATIONS

(71) Applicant: SKYWORKS SOLUTIONS, INC., Woburn, MA (US)

(72) Inventor: David Richard PEHLKE, Westlake Village, CA (US)

(21) Appl. No.: 15/043,574

(22) Filed: Feb. 14, 2016

Related U.S. Application Data
(60) Provisional application No. 62/116,456, filed on Feb. 15, 2015.

(51) Int. Cl. H02J 1/00; H04W 52/02; H04B 1/40; H02M 3/04; H04B 1/3827

(52) U.S. Cl. CPC H02J 1/00; H02M 3/04; H04B 1/3827; H04B 1/40; H04W 52/0209

(57) ABSTRACT

A power supply for a portable electronic device is disclosed, comprising an assembly of secondary cells interconnected with a plurality of switches and a DC-DC converter coupled to a portion of the assembly of secondary cells, such that the power supply has an efficiency that is higher than an efficiency of the DC-DC converter.

### CROSS-REFERENCE TO RELATED APPLICATION(S)

This application claims priority to U.S. Provisional Application No. 62/116,456 filed Feb. 15, 2015, entitled RECONFIGURABLE POWER SUPPLY CELL FOR EFFICIENT BOOST AND BUCK-BOOST APPLICATIONS, the disclosure of which is hereby expressly incorporated by reference herein in its entirety.

### BACKGROUND

1. Field

The present disclosure relates to circuit designs for voltage supply systems.

2. Description of the Related Art

Standard secondary cell batteries exhibit fixed voltage discharge curves over a limited range of values from Vmax at full charge to Vmin at cutoff. In some applications of front-end radio electronics such as mobile phones, there is often a need for efficient generation of voltages significantly higher, or lower than this limited range, and any power lost to the limited efficiency of this conversion is undesirable.

### SUMMARY

According to some implementations, the present disclosure relates to a power supply for a portable electronic (e.g., wireless) device that includes an assembly of secondary cells interconnected with a plurality of switches and a DC-DC converter coupled to a portion of the assembly of secondary cells, such that the power supply has an efficiency that is higher than an efficiency of the DC-DC converter.

In some embodiments, the DC-DC converter of the power supply is a buck converter. In some embodiments, the power supply includes a safety circuit that includes at least one of the plurality of switches. In some embodiments, at least one of the plurality of switches provides an electrical connection between two of the secondary cells.

In some embodiments, one or more switches of the plurality of switches are closed so that at least two of the secondary cells are connected in series. In some embodiments, one or more switches of the plurality of switches are closed so that at least two of the secondary cells are connected in parallel.

In some embodiments, the secondary cells are Lithium ion batteries. In some embodiments, the power supply includes a control circuit coupled to a portion of the assembly of secondary cells and coupled to one or more sensors.

In some embodiments, the control circuit of the power supply is configured to open or close one or more switches of the assembly based on data obtained from the one or more sensors. In some embodiments, the control circuit is configured to open or close one or more switches of the assembly based on a determined preferred output voltage or current handling capacity of the power supply.

A power management system is disclosed, including one or more sensors and a power supply coupled to the one or more sensors. The power supply includes an assembly of secondary cells interconnected with a plurality of switches and a DC-DC converter coupled to a portion of the assembly of secondary cells, such that the power supply has an efficiency that is higher than an efficiency of the DC-DC converter.

A wireless device is disclosed, including a transceiver configured to generate a radio-frequency (RF) signal, an amplification system configured to amplify the RF signal and a power management system configured to provide power to the amplification system. The power management system includes one or more sensors and an assembly of secondary cells. The power management system further including a plurality of switches configured to interconnect the assembly of secondary cells, including a DC-DC converter coupled to a portion of the assembly of secondary cells, such that the power management system has a power supply efficiency that is higher than an efficiency of the DC-DC converter.

A method of operating a power supply system is disclosed, including configuring an assembly of secondary cells interconnected with a plurality of switches and a DC-DC converter coupled to a portion of the assembly of secondary cells, of the power supply. The method includes determining a preferred output voltage or current handling capacity for the power supply and determining a respective required state for each respective switch of the plurality of switches to provide the preferred output voltage or current handling capacity for the power supply. The method further includes activating one or more switches of the plurality of switches in accordance with the respective required state for each respective switch.

In some embodiments, configuring the assembly includes providing an efficiency of the power supply system that is higher than an efficiency of the DC-DC converter.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows an example circuit where four cells are connected in parallel, in accordance with some embodiments.

FIG. 2 shows an example circuit where four cells are connected in series, in accordance with some embodiments.

FIG. 3A shows an example assembly of cells and switches, in accordance with some embodiments.

FIG. 3B shows an example set of switches, in accordance with some embodiments.

FIG. 3C shows an example switch configuration in an assembly of cells and switches, in accordance with some embodiments.

FIG. 3D shows an example switch configuration in an assembly of cells and switches, in accordance with some embodiments.

FIG. 4 shows another example combination and arrangement of cells and switches, in accordance with some embodiments.

FIG. 5 shows an example combination of a power supply and a buck converter having a bypass, in accordance with some embodiments.

FIG. 6 shows an example combination of an assembly of cells and switches and a buck converter having a bypass, in accordance with some embodiments.

FIG. 7 illustrates a simplified power supply circuit for the purpose of calculating efficiency of the supply, in accordance with some embodiments.

FIG. 8 illustrates an example power supply circuit with a set of secondary cells connected in series and a buck converter coupled to a portion of the assembly, in accordance with some embodiments.

FIG. 9 shows an example power management system implementing some or all of the power supply having one or more advantageous features described herein.

FIG. 10 illustrates a method that can be implemented to provide one or more features as described herein.

FIG. 11 depicts an example wireless device having one or more advantageous features described herein.

### DETAILED DESCRIPTION OF SOME EMBODIMENTS

The headings provided herein, if any, are for convenience only and do not necessarily affect the scope or meaning of the claimed invention.

Conventional power supply circuit implementations typically rely on DC-DC converter technologies to generate a desired supply voltage from an available input single cell voltage. These are typically based on, for example, boost, buck, and/or buck-boost topologies with reasonable but limited efficiencies. These converters can have the advantage of flexible programmable output voltages, but can also suffer worse converter efficiency than desired.

Also present in conventional secondary cell power management systems are safety circuits of inline switches which are combined with sensors and circuits for protection against electrical and environmental issues such as over-temperature and over-voltage conditions. Such safety circuits can shut off these switches and operation of the cell when dangerous operating conditions are detected. These switches typically serve no other purpose than the safe operation of the secondary cell in conventional implementations.

It is noted that widely used secondary cell technologies for portable electronic applications currently include Lithium ion (Li-ion) and Lithium polymer (Li-polymer) batteries with a cell voltage in a range of about 3.7V. These secondary cell technologies are typically selected based on a number of performance criteria, including, for example, light weight, reasonable cell voltage range, maximum current and discharge characteristics, energy density, reliability, charging life, intrinsic cell resistance, thermal properties, and range of safe operation.

In earlier times, cellular devices commonly utilized NiMH secondary cells which were heavier and had lower energy density. These also had a lower cell voltage in a range of about 1.15V per cell. Accordingly such cells were arranged in a stacked configuration to provide a reasonable total voltage for the electronics they powered. These cells were balanced through the charging electronics to maintain symmetric and optimal discharge of the power management system.

Disclosed are examples of switch configurations that allow use of stacked secondary cells to obtain desired voltages, including boosted total voltages, and also allow changes in the connections of the cells in a flexible manner (e.g., in series, parallel, or some combination thereof) to provide a number of discrete boosted voltages. By connecting cells in parallel, a single cell voltage can be delivered at higher capacity. By stacking cells in series, higher voltages in step sizes approximately equal to an integer number of the single cell voltage can be achieved. Such stacking of discrete combinations of parallel and/or series connections with small resistive insertion loss can yield much higher efficiency boost functionality than conventional DC-DC converter approaches.

Further, some or all of the foregoing switches can be combined with, for example, temperature and over-voltage sensors to perform a function of safety switching to prevent unsafe operation and aid in the balancing of multiple cells in various charging configurations.

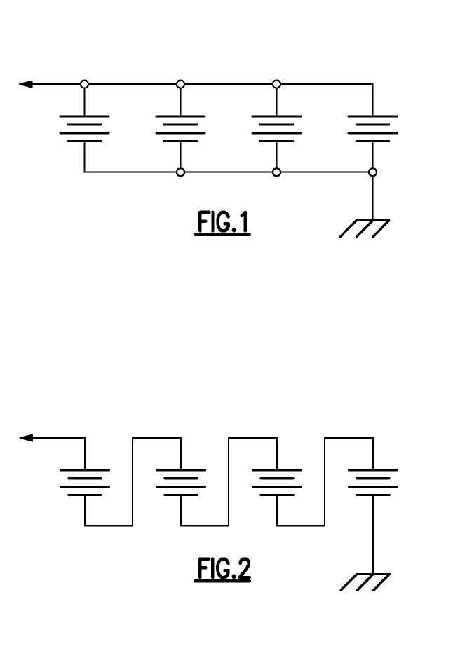

FIG. 1 shows an example where four cells (e.g., voltage supplies or batteries) are connected in parallel. An arrangement of cells in parallel is desirable in electronic applications requiring an increased capacity for current handling, measured in amperes/hour (Ah). If all four cells of the parallel connection have the same voltage, an arrangement such as the one shown in FIG. 1 provides the same output voltage as any one of the four cells. In a parallel multi-cell configuration as shown in FIG. 1, if one of the four cells develops a high-resistance or “opens”, the overall capacity for current handling will decrease but the output voltage will remain the same.

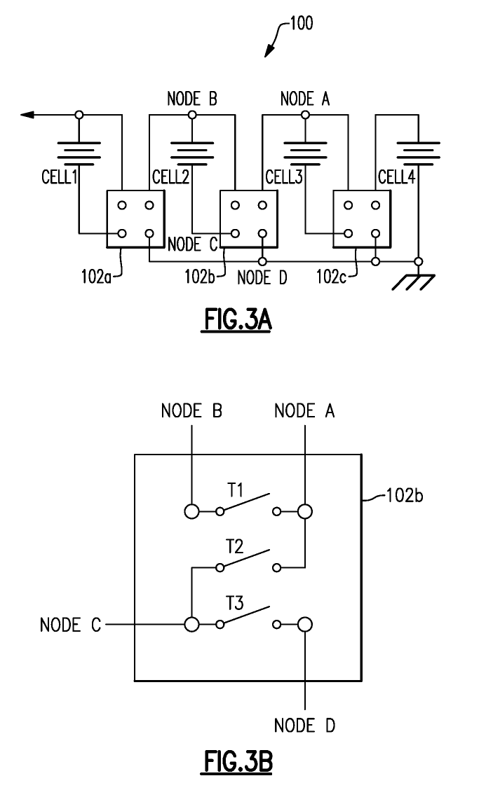

FIG. 2 shows an example where four cells are connected in series. An arrangement of cells in series is desirable in electronic applications requiring a higher voltage than can be provided by a single cell. The circuit topology shown in FIG. 2 provides the same current handling capacity as a single cell of the multiple cells in series. A challenge with series cell configurations is that a weak cell tends to degrade the overall performance of the entire circuit, since the weak cell cannot charge to the same capacity as the other cells, and creates an imbalance in the circuit.

It will be understood by one of ordinary skill in the art that other numbers of cells can be utilized for the arrangements described with respect to FIGS. 1 to 8. In some embodiments each cell of a set of cells described as a part of a circuit in the present disclosure, has a substantially similar voltage to all other cells of the set (e.g., all four cells of a circuit have an approximately 3.5 V reading). In some embodiments each cell of a set of cells described as a part of a circuit in the present disclosure, has a substantially dissimilar voltage to all other cells of the set.

In some embodiments, switches can be implemented to connect multiple cells in some combination of series and parallel to yield a reconfigurable assembly of cells. In some embodiments, one battery pack or set of cells is configured for use with a plurality of electronic devices or a plurality of types of electronic devices. As a result, a circuit topology of cells with switches to create series and/or parallel connections can allow for various output voltages and current handling capacities. Preferably, such an assembly of cells occupy minimal or reduced area and total loss.

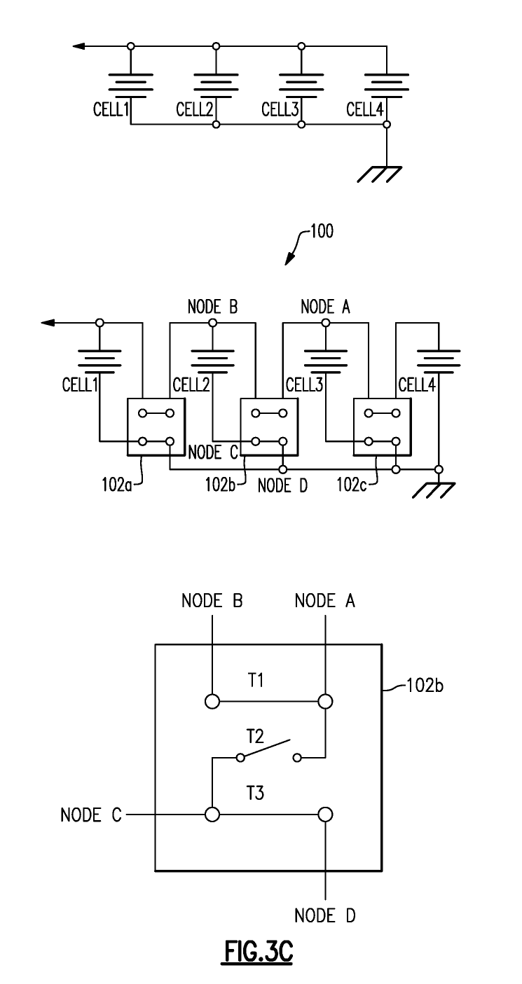

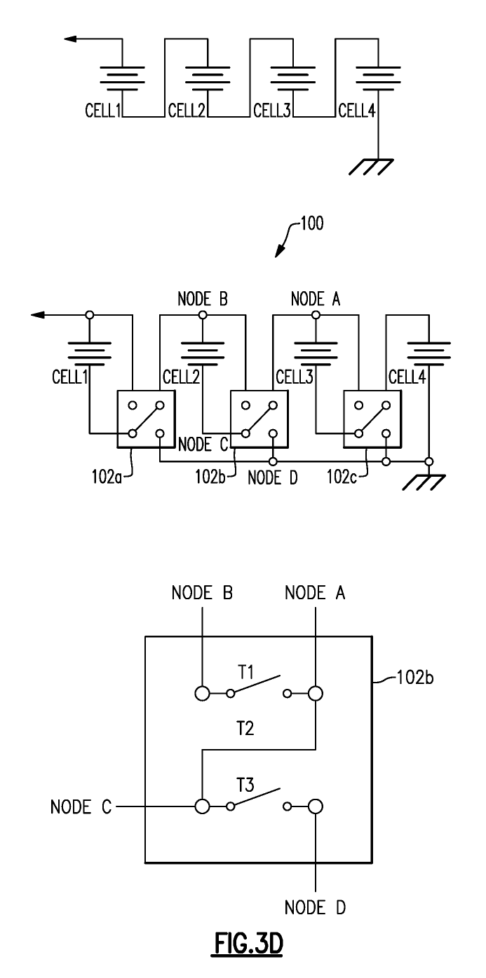

FIG. 3A shows an example assembly (e.g., circuit, combination and/or configuration) 100 of cells and switches, or sets 102 of switches. In such a combination, there are 12 switch throws. A set of switches indicated as 102b is shown in greater detail in FIG. 3B. For example, set of switches 102b includes three switch throws, T1, T2 and T3 which can open or close to connect or disconnect Node A, Node B, Node C and/or Node D. In some embodiments, at least one node of a set of switches is connected to ground (e.g., Node D in FIG. 3B).

FIG. 3B shows that if switch throw T1 is closed, Node A and Node B are connected, if switch throw T2 is closed, Node A and Node C are connected, and if switch throw T3 is closed, Node C and Node D are connected.

FIG. 3C illustrates one possible configuration of the cells of assembly 100, so that all the cells are connected in parallel. In this example, switch throw T1 and switch throw T3 of set of switches 102b are closed. Similarly, T1 and T3 of sets 102a and 102c are closed. This electrically connects each of the positive terminals of Cell 1 to Cell 4 to each other, and connects each of the negative terminals of Cell 1 to Cell 4 to each other as well.

In some embodiments, a control circuit (not shown), is coupled to the sets of switches 102 and/or individual switch throws to activate switch throws. In some embodiments, sets of switches 102 and/or individual switch throws are configured to provide safety or bypass functions, such as disconnecting one or more portions of assembly 100. In some embodiments, these switches, switch throws and/or sets of switches were already required and in place to provide safety and bypass functionality, therefore no additional components are required to implement a reconfigurable power supply system, as described in this disclosure.

FIG. 3D illustrates another possible configuration of the cells of assembly 100, so that all the cells are connected in series. In this example, only switch throw T2 is activated, or in this case, closed, to form a connection between Node A and Node C, with respect to switch set 102b. Similarly, T2 of sets 102a and 102c are closed. This electrically connects a positive terminal of one cell with the negative terminal of its adjacent cell (e.g., positive terminal of Cell 3 connected to negative terminal of Cell 2).

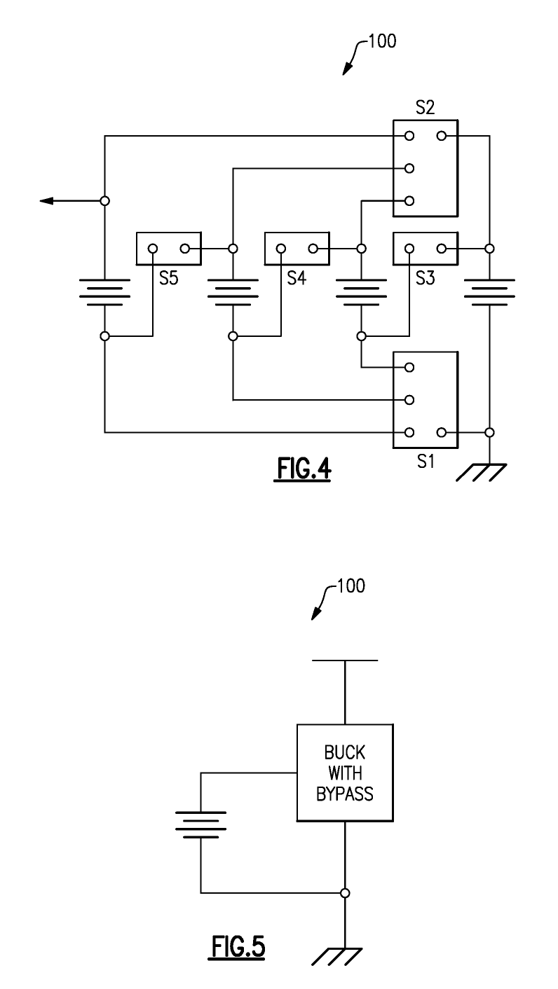

FIG. 4 shows another example combination 100 of cells and switches. In such a combination, there are 9 switch throws. Table 1 lists examples of total resistances of the combinations of FIGS. 3A and 4. In Table 1, it is assumed that each switch has a resistance or R, and the four cells have voltages V1 to V4.

TABLE 1

| | Total resistance for | Total resistance for |
|---|---|---|
| Configuration | FIG. 3A | FIG. 4 |
| V1 + V2 + V3 + V4 | 3R | 3R |
| V1 + V2 + V3 ∥ V4 | 2R + (R/2) | 2R + (R/2) |
| V1 + V2 ∥ V3 ∥ V4 | R + (R + (R/2)) ∥ R | R + (R/3) ∥ R |
| V1 ∥ V2 ∥ V3 ∥ V4 | [[((R/2) + R) ∥ R] + R] ∥ R | R/3 |

FIG. 4 illustrates that a variety of configurations of cells and switches (e.g., safety or bypass circuit switches) can be implemented, particularly to provide optimal performance for a primary circuit topology of the power supply. For example, if an arrangement is desired with all the cells in parallel for typical uses of the power supply, an arrangement such as the one shown in FIG. 4 reduces the total amount of resistance as compared to the arrangement shown and described in FIG. 3C.

In some embodiments, some or all of the switches in the combinations of FIGS. 3A and 4 can be utilized for safety circuits. In some embodiments, a switch is a PFET.

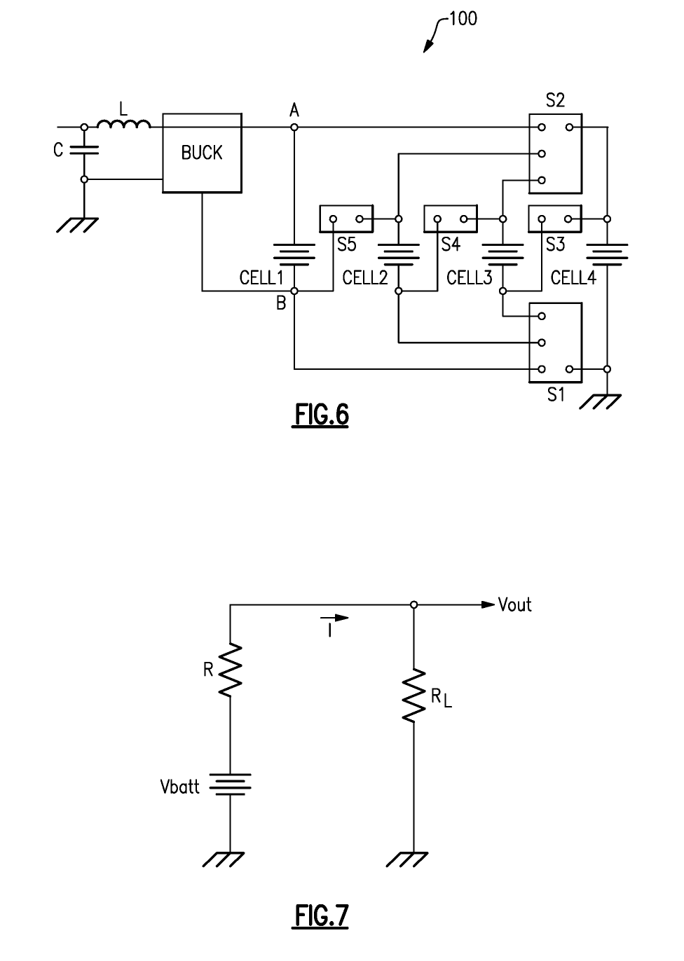

In some embodiments, one or more cells can be combined with a buck converter. FIG. 5 shows an example combination 100 where a cell is combined with a buck converter having a bypass. In such a combination, a finite efficiency of a single buck converter can be forced on the entire cell voltage.

FIG. 6 shows an example combination 100 in which a buck converter is combined with a cell/switch combination similar to the example of FIG. 4. In the example of FIG. 6, the buck converter is not ground referenced, but operates on whatever is across the nodes A and B.

In the example of FIG. 6, the buck converter can be reconfigured along with the switched cells, such that its finite efficiency and power handling is limited to what is connected across the nodes A and B. If all four cells are connected in parallel, the buck converter bucks all four cells. If Cell1 is connected in series with others, the buck converter bucks only Cell1. Other combinations are also possible.

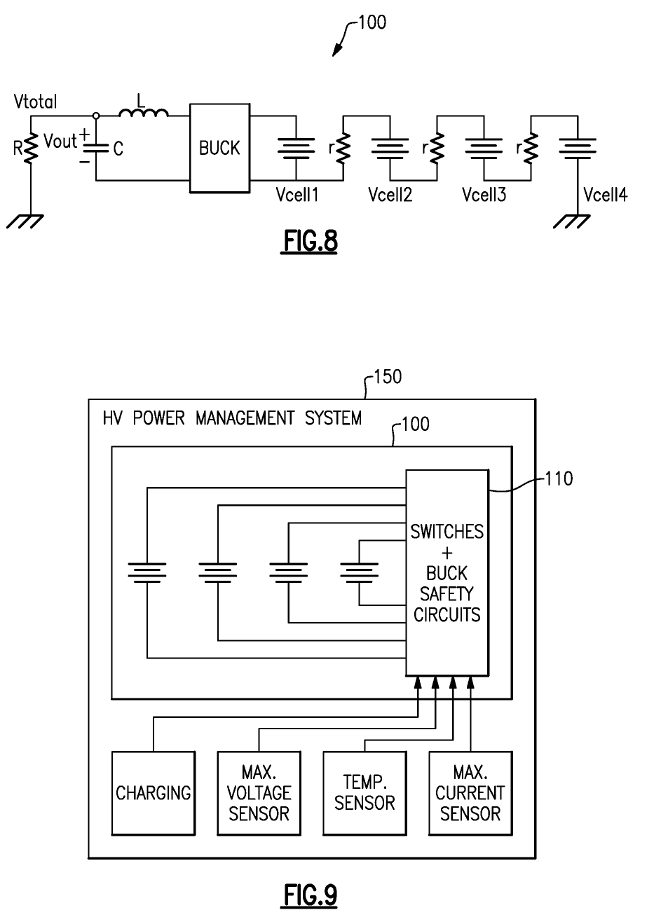

FIG. 7 illustrates a simplified power supply circuit for the purpose of calculating efficiency of the supply. It is noted that efficiency of a battery or secondary cell without resistance is essentially 100%. Referring to FIG. 7, it is noted that efficiency of the battery can be calculated as

$$η = \frac{{V}_{out} {I}_{out}}{{V}_{Batt} {I}_{out}} = \frac{{V}_{out}}{{V}_{Batt}} = \frac{{R}_{L}}{R + {R}_{L }} .$$

If R_{L} is 50Ω and R is 1Ω, then the efficiency η is high at approximately 98%.

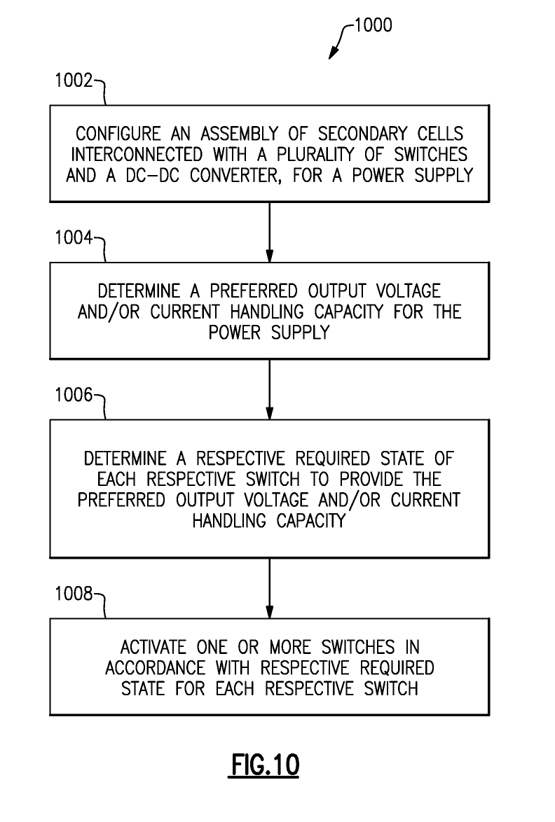

FIG. 8 illustrates an example power supply circuit with a set of secondary cells connected in series and a buck converter coupled to a portion of the assembly 100 of cells and switches (not shown). If a buck converter only operates on a portion of the total voltage, then its efficiency can be combined with a much higher efficiency (e.g., as in the example of FIG. 7) of the standard cell(s). For example, referring to FIG. 8, assume that each resistance r is approximately 1Ω, and the load resistance R is approximately 50Ω. Then, as described in reference to FIG. 7, the stack of four cells is approximately 94% efficient. Assuming that the buck converter has an efficiency of 90%, Vcell1 can be bucked to Vcell/2 with the same 90% efficiency. When such a bucked voltage is combined with the three remaining cell voltages, the overall efficiency can be calculated as [(Vcell/2)+3 Vcell]/[(Vcell/2)/(0.9)+(3 Vcell)/(50/53)], which is approximately 93.7%.

In some embodiments, combinations of cells and switches as described herein can be utilized in a high-voltage (HV) power management system. FIG. 9 shows an example of an HV power management system 150 that includes a combination 110 of a plurality of cells connected through switches, one or more buck converters, and/or one or more safety circuits. As described herein, some or all of the switches for connecting the cells can also be utilized for some or all of the safety circuits.

In the example of FIG. 9, the safety circuits can receive inputs from, for example, a charging circuit, a maximum voltage sensor, a temperature sensor, and/or a maximum current sensor. In some embodiments, combination 110 includes a control circuit. In some embodiments the control circuit is coupled to at least a portion of the plurality of cells, switches, buck converters and/or safety circuits. In some embodiments, the control circuit receives inputs from one or more of the charging circuit, maximum voltage sensor, temperature sensor and/or maximum current sensor or any other environmental or electrical sensor.

FIG. 10 illustrates a method 1000 that can be implemented to provide one or more features as described herein. In some embodiments, method 1000 is implemented at a power supply, a power supply system, an RF module and/or a wireless device, as described in this disclosure. In some embodiments, method 1000 is a method for operating a power supply. In block 1002, the method 1000 can configure an assembly of secondary cells interconnected with a plurality of switches and a DC-DC converter coupled to a portion of the assembly of secondary cells, of the power supply. In some embodiments, configuring the assembly includes providing an efficiency of the power supply system that is higher than an efficiency of the DC-DC converter. For example, as described above with respect to FIGS. 5 to 8, a DC-DC converter can be arranged within an assembly or coupled to a portion of an assembly of cells and switches to provide a fine tuning of an output voltage.

Block 1004 illustrates that method 1000 includes determining a preferred output voltage and/or current handling capacity for the power supply. For example, a particular electronic device relies on this power supply to ideally provide 3.7 V. Block 1006 shows that method 1000 includes determining a respective required state for each respective switch (e.g., switch throw) of the plurality of switches to provide the preferred output voltage or current handling capacity for the power supply.

Block 1008 illustrates that method 1000 can activate one or more switches of the plurality of switches in accordance with the respective required state for each respective switch. For example, as shown in FIG. 3C if only a single cell voltage is required, switch throws T1 and T3 of each set of switches 102, are determined to need to be closed to provide the correct circuit topology to achieve the desired or preferred output voltage.

As described herein, a number of desirable advantageous features can be realized. For example, and as described in reference to FIGS. 5 and 6, use of a buck converter referenced to one of the cells in an assembly of cells and switches can enable fine tuning of a precise output voltage, while enabling much higher efficiency overall by limiting the efficiency of the buck converter degrading the overall efficiency of the connection. As described herein, the buck efficiency only affects a small voltage portion of the boosting stack of cells when the buck converter is coupled to the stack appropriately.

Advantages can further include realization of a highly efficient boost supply at a number of fixed available voltages (e.g., integer multiples of the single cell voltage) with improved efficiency over and above that of conventional DC-DC converter solutions. For example, in an assembly of four secondary cells and a plurality of switches, switches are activated so that two cells are in parallel, and so that the parallel pair of cells is in series with the other two cells. This would result in a voltage of three times the single cell voltage, without requiring a DC-DC converter to boost the voltage to that level.

In another example, some or all of the reconfiguration switches can be re-used to serve as the safety switches utilized in multiple-cell applications. In yet another example, addition of a buck converter with a ground reference tied to the lower terminal of one of the cells can yield a precise and programmable output voltage from the circuit, while only marginally affecting the overall efficiency. In yet another example, use of an added buck converter can provide low power efficiency with the same configuration when all cells are connected in parallel and delivering a single cell voltage to the input of the buck converter.

In some implementations, a device and/or a circuit having one or more features described herein can be included in an RF device such as a wireless device. Such a device and/or a circuit can be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, etc.

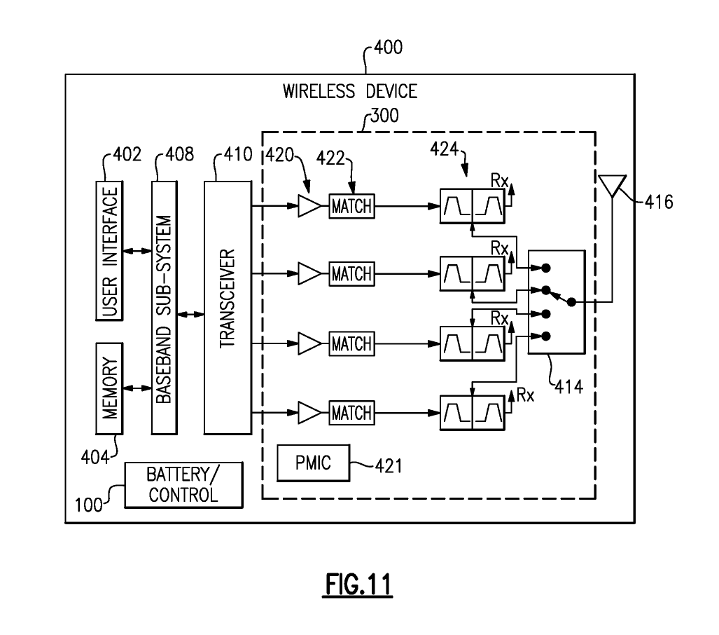

FIG. 11 depicts an example wireless device 400 having one or more advantageous features described herein. In the context of a combination of cells and switches (and optionally further including a buck converter and/or a safety circuit), such a combination can be implemented in connection with an assembly, a battery or control of such a battery (collectively indicated as 100 in FIG. 10). In some embodiments, assembly 100 has one or more of the features described above with respect to FIGS. 3A to 9.

Referring to FIG. 11, power amplifiers (PAs) 420 can receive their respective RF signals from a transceiver 410 that can be configured and operated in known manners to generate RF signals to be amplified and transmitted, and to process received signals. The transceiver 410 is shown to interact with a baseband sub-system 408 that is configured to provide conversion between data and/or voice signals suitable for a user and RF signals suitable for the transceiver 410.

The baseband sub-system 408 is shown to be connected to a user interface 402 to facilitate various input and output of voice and/or data provided to and received from the user. The baseband sub-system 408 can also be connected to a memory 404 that is configured to store data and/or instructions to facilitate the operation of the wireless device, and/or to provide storage of information for the user.

In the example wireless device 400, outputs of the PAs 420 are shown to be matched (via respective match circuits 422) and routed to their respective duplexers 420. Such amplified and filtered signals can be routed to an antenna 416 through an antenna switch 414 for transmission. In some embodiments, the duplexers 420 can allow transmit and receive operations to be performed simultaneously using a common antenna (e.g., 416). In FIG. 11, received signals are shown to be routed to “Rx” paths (not shown) that can include, for example, a low-noise amplifier (LNA). In FIG. 11, a number of components such as the PAs, matching networks, duplexers, and the antenna switch module can be included in a front-end module 300.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A power supply for a portable electronic device, the power supply comprising:
an assembly of secondary cells interconnected with a plurality of switches; and
a DC-DC converter coupled to a portion of the assembly of secondary cells, such that the power supply has an efficiency that is higher than an efficiency of the DC-DC converter.

2. The power supply of claim 1 wherein the DC-DC converter is a buck converter.

3. The power supply of claim 1 further comprising a safety circuit that includes at least one of the plurality of switches.

4. The power supply of claim 1 wherein at least one of the plurality of switches provides an electrical connection between two of the secondary cells.

5. The power supply of claim 4 wherein one or more switches of the plurality of switches are closed so that at least two of the secondary cells are connected in series.

6. The power supply of claim 4 wherein one or more switches of the plurality of switches are closed so that at least two of the secondary cells are connected in parallel.

7. The power supply of claim 1 wherein the secondary cells are Lithium ion batteries.

8. The power supply of claim 1 further comprising a control circuit coupled to a portion of the assembly of secondary cells and coupled to one or more sensors.

9. The power supply of claim 8 wherein the control circuit is configured to open or close one or more switches of the assembly based on data obtained from the one or more sensors.

10. The power supply of claim 8 wherein the control circuit is configured to open or close one or more switches of the assembly based on a determined preferred output voltage or current handling capacity of the power supply.

11. A power management system comprising:
one or more sensors; and
a power supply coupled to the one or more sensors, the power supply including an assembly of secondary cells interconnected with a plurality of switches and a DC-DC converter coupled to a portion of the assembly of secondary cells, such that the power supply has an efficiency that is higher than an efficiency of the DC-DC converter.

12. The power management system of claim 11 wherein the DC-DC converter is a buck converter.

13. The power management system of claim 11 further comprising a safety circuit that includes at least one of the plurality of switches.

14. The power management system of claim 11 wherein at least one of the plurality of switches provides an electrical connection between two of the secondary cells.

15. (canceled)

16. (canceled)

17. (canceled)

18. The power management system of claim 11 further comprising a control circuit coupled to a portion of the assembly of secondary cells and coupled to the one or more sensors.

19. The power management system of claim 18 wherein the control circuit is configured to open or close one or more switches of the assembly based on data obtained from the one or more sensors.

20. The power management system of claim 18 wherein the control circuit is configured to open or close one or more switches of the assembly based on a determined preferred output voltage or current handling capacity of the power supply.

21. A wireless device comprising:
a transceiver configured to generate a radio-frequency (RF) signal;
an amplification system configured to amplify the RF signal; and
a power management system configured to provide power to the amplification system, the power management system including one or more sensors and an assembly of secondary cells, the power management system further including a plurality of switches configured to interconnect the assembly of secondary cells, the power management system further including a DC-DC converter coupled to a portion of the assembly of secondary cells, such that the power management system has a power supply efficiency that is higher than an efficiency of the DC-DC converter.

22. The wireless device of claim 21 wherein the DC-DC converter is a buck converter.

23. The wireless device of claim 21 further comprising a safety circuit that includes at least one of the plurality of switches.

24-41. (canceled)
